(19) United States
(12) Patent Application Publication
(10) Pub. No.: US 2008/0028554 A1
(43) Pub. Date: Feb. 7, 2008

(54) CLEANING KIT FOR THE INTERIOR OF A MOTOR VEHICLE

(75) Inventors: Gerry Chu, Toronto (CA); Andrew J. Frost, Eden Prairie, MN (US); Minette A. Vacariello, Pittsburgh, PA (US); Allan Velzy, San Francisco, CA (US); Jessica Mellon, Union, NJ (US)

Correspondence Address: INTERNATIONAL TRUCK INTELLECTUAL PROPERTY COMPANY,, 4201 WINFIELD ROAD, P.O. BOX 1488, WARRENVILLE, IL, 60555, US

(73) Assignee: International Truck Intellectual Property Company, LLC, Warrenville, IL (US)

(21) Appl. No.: 11/752,689

(22) Filed: May 23, 2007

Related U.S. Application Data
(60) Provisional application No. 60/803,072, filed on May 24, 2006.

(51) Int. Cl. A46B 15/00; A47L 25/00; B25G 1/10

(52) U.S. Cl. 15/106; 15/105; 15/143.1

(57) ABSTRACT

A set of cleaning tools (30, 40, 50, 60, 70, 80), each of which has a respective handle (82) to which a respective cleaning element is attached. Each handle is sized for single-handed grasping and has a main plastic body with recesses running lengthwise along opposite sides of the main body for a majority of the length of the main body, thermoplastic elastomer filling the side recesses of the main body, and plastic end caps disposed on the main body at lengthwise opposite ends of the main body beyond the thermoplastic elastomer in the side recesses. The handle materials have distinctive colors for correlation with a particular brand of motor vehicle.

### REFERENCE TO RELATED APPLICATION AND PRIORITY CLAIM

This application claims the priority of Provisional Patent Application No. 60/803,072, filed on 24 May 2006, the entirety of which is incorporated herein by reference.

### FIELD OF THE INVENTION

This invention relates to a cleaning kit comprising various hand-held cleaning tools that are useful for cleaning the interior of a motor vehicle, especially that of a heavy truck.

### BACKGROUND OF THE INVENTION

Unlike the exterior of a truck or car, the interior is typically not exposed to wet conditions, except for the occasional tracking of snow, mud, rainwater, etc. when getting into the cab, the possible intrusion of same through an open door or window, and/or an occasional beverage spill. The interior is more likely to collect dust on exposed surfaces, and of course the floor can be dirtied as a result of the tracking of undesired substances into the interior on the driver's shoes.

Hence typical interior cleaning tasks involve the removal of dry substances such as dust, dirt, and small pieces of gravel. Various power and non-power cleaning tools are available on the commercial market for performing interior cleaning tasks.

A vacuum may be used to vacuum the interior of a motor vehicle and may include different nozzle attachments. For example, a crevice tool attachment can be used to vacuum hard-to-get-at places. A vacuum operates by sucking dust, dirt and other debris, and while a vacuum attachment may aid the cleaning process, hand-held tools may be preferred over a power tool in certain ways.

For example, a hand-held tool may have certain advantages over a powered tool such as a vacuum because it can be better manipulated in certain areas. Also the manner in which a person applies force to a hand-held tool may be more favorable for dislodging debris than in the case of a suction by a vacuum, even when using a vacuum attachment such as a brush attachment.

The inventors believe that a kit that comprises a set of hand-held cleaning tools that are specifically adapted for enabling a truck driver to perform a number of different cleaning tasks on the interior of a large highway truck so that the entire interior can appear to have been professionally detailed would enjoy commercial acceptance, especially if they possess a stylish appearance. Professional truckers, particularly individual owner/operators, take pride in their trucks. It is believed that an owner/operator would take similar pride in owning a set of cleaning tools that are have constructions that are not merely functional for their intended purposes, but that in some way identify with the particular truck that the owner/operator has purchased or leased.

### SUMMARY OF THE INVENTION

The present invention is directed toward such a set of cleaning tools. Apart from tools that possess such an attribute, individual tools themselves have novel constructions.

A general aspect of the invention relates to a cleaning tool comprising that comprises a cleaning element and a handle to which the cleaning element is attached.

The handle is sized for single-handed grasping, and comprises a main body of injection-molded plastic, such as high density polyethylene, having a particular color and comprising recesses running lengthwise along opposite sides of the main body for a majority of the length of the main body, plastic of a different color, such as high density polyethylene, that has been injection-molded onto opposite lengthwise ends of the main body, and thermoplastic elastomer that has been injection-molded into the side recesses of the main body.

Another general aspect relates to a kit comprising a carrying case for a set of cleaning tools and a set of cleaning tools for carrying in the case.

Each tool comprises a respective handle to which a respective cleaning element is attached. Each handle is sized for single-handed grasping and comprises a main plastic body comprising recesses running lengthwise along opposite sides of the main body for a majority of the length of the main body. Thermoplastic elastomer is disposed in the side recesses of the main body. Plastic end caps are disposed on the main body at lengthwise opposite ends of the main body beyond the thermoplastic elastomer in the side recesses.

The foregoing, along with further features and advantages of the invention, will be seen in the following disclosure of a presently preferred embodiment of the invention depicting the best mode contemplated at this time for carrying out the invention. This specification includes drawings, now briefly described as follows.

### BRIEF DESCRIPTION OF THE DRAWINGS

FIG. 1 is a perspective view generally from the right rear of a first embodiment of tool illustrating principles of the present invention.

FIG. 2 a right side view of the tool of FIG. 1.

FIG. 3 is a perspective view illustrating use of the tool of FIG. 1.

FIG. 4 is a perspective view generally from the left front of a second embodiment of tool illustrating principles of the present invention.

FIG. 5 a left side view of the tool of FIG. 4.

FIG. 6 is a perspective view illustrating use of the tool of FIG. 4.

FIG. 7 is a perspective view generally from the right rear of a third embodiment of tool illustrating principles of the present invention.

FIG. 8 a right side view of the tool of FIG. 7.

FIG. 9 is a perspective view illustrating use of the tool of FIG. 7.

FIG. 10 is a perspective view generally from the right rear of a fourth embodiment of tool illustrating principles of the present invention.

FIG. 11 a right side view of the tool of FIG. 10.

FIG. 12 is a perspective view illustrating use of the tool of FIG. 10.

FIG. 13 is a perspective view generally from the left front rear of a fifth embodiment of tool illustrating principles of the present invention.

FIG. 14 a left side view of the tool of FIG. 13.

FIG. 15 is a perspective view illustrating use of the tool of FIG. 13.

FIG. 16 is a perspective view generally from the right rear of a sixth embodiment of tool illustrating principles of the present invention.

FIG. 17 another perspective view of the tool of FIG. 16 from a slightly different angle.

FIG. 18 is a perspective view illustrating use of the tool of FIG. 16.

FIG. 19 is a perspective view of the six tools including a carrying case that collectively form a kit of cleaning tools.

### DESCRIPTION OF THE PREFERRED EMBODIMENT

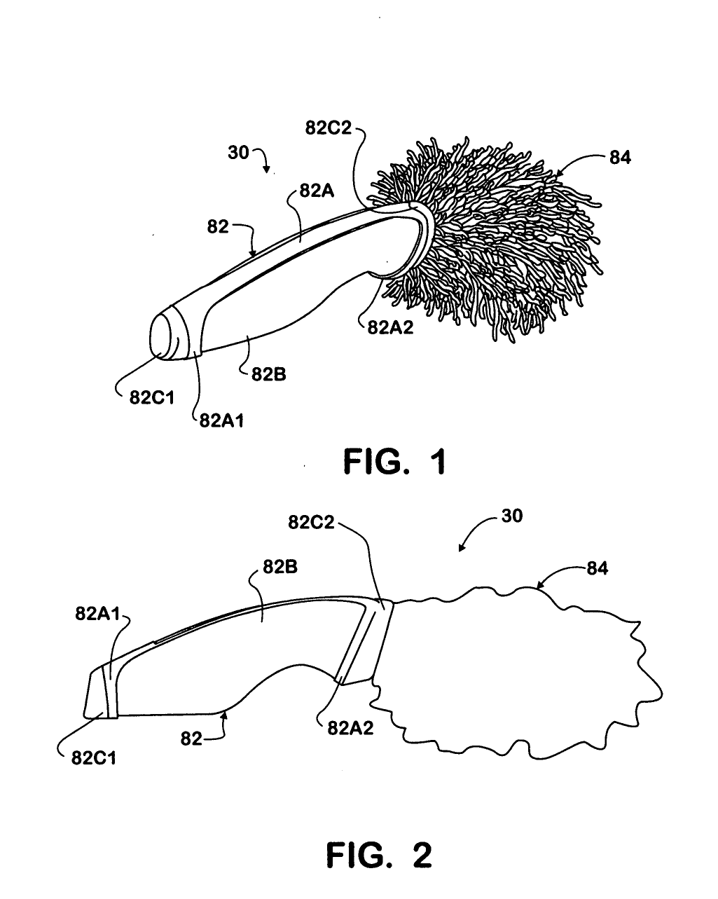

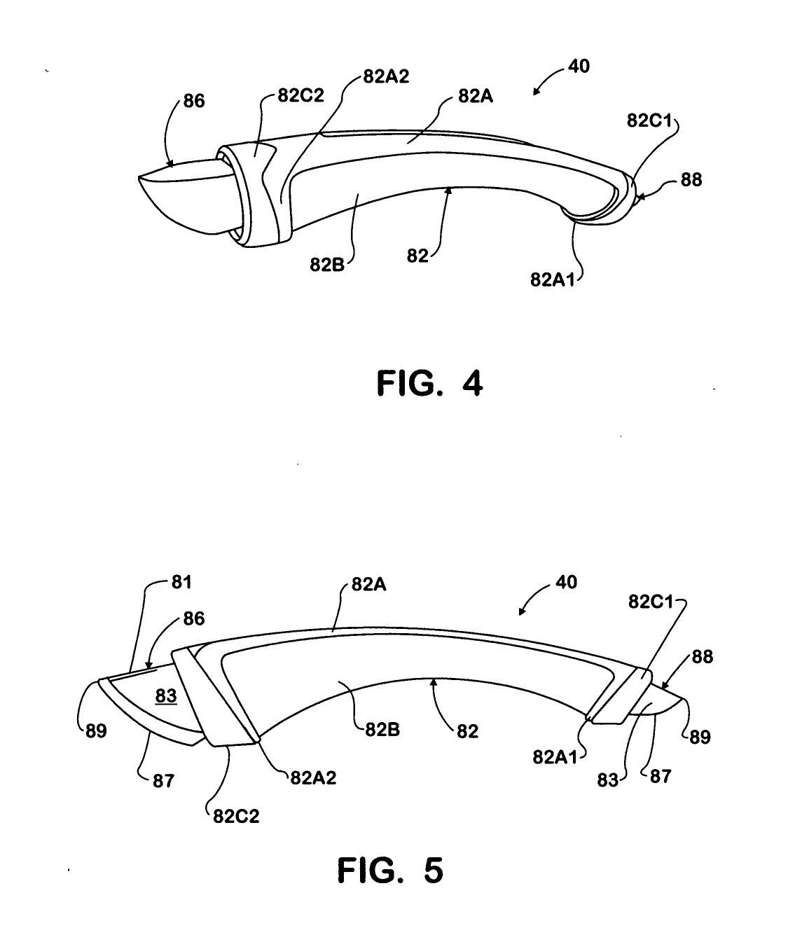

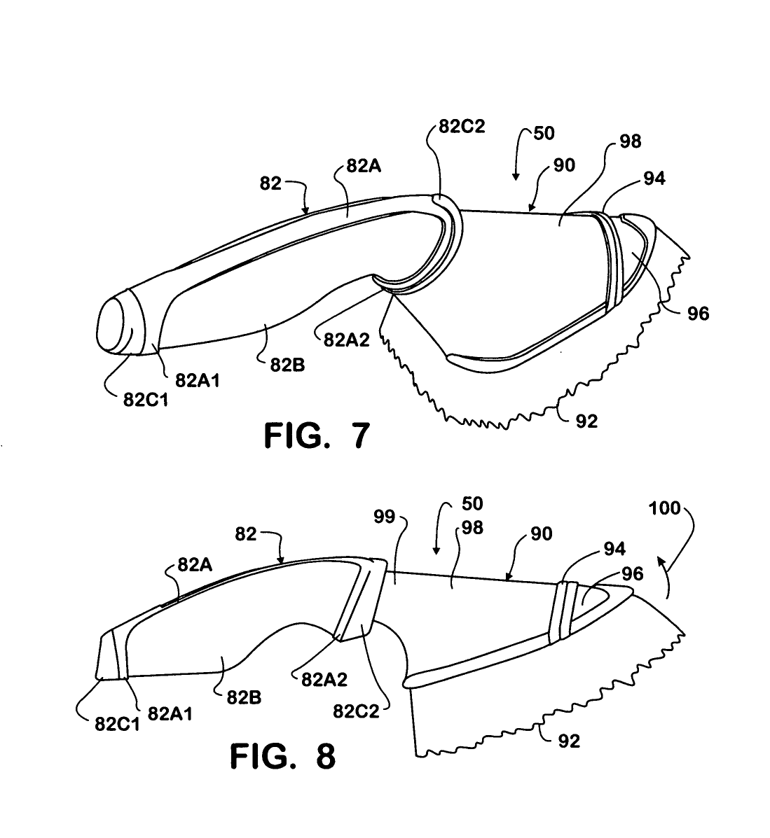

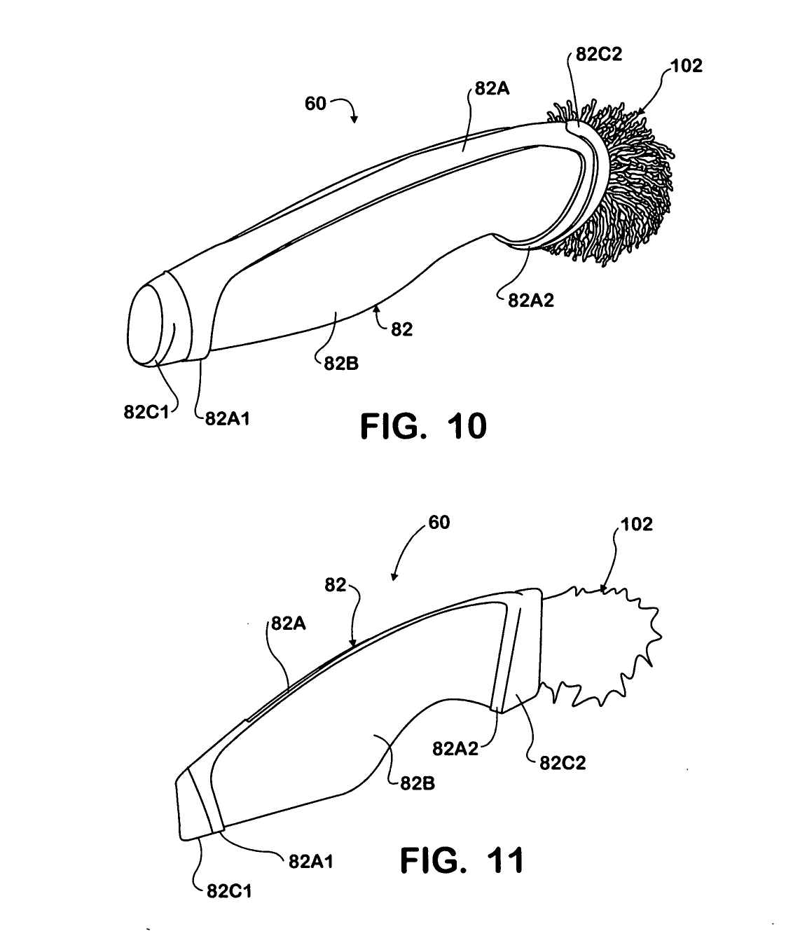

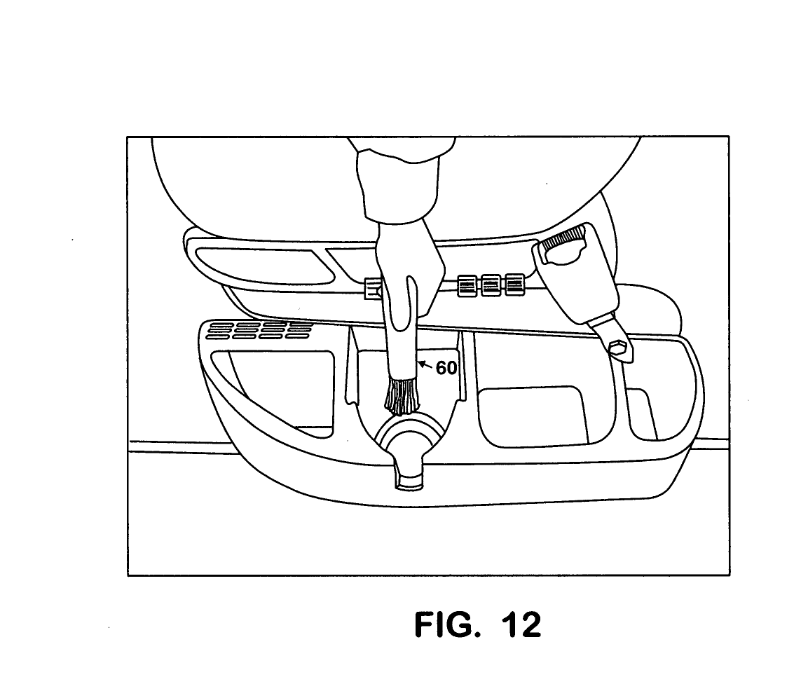

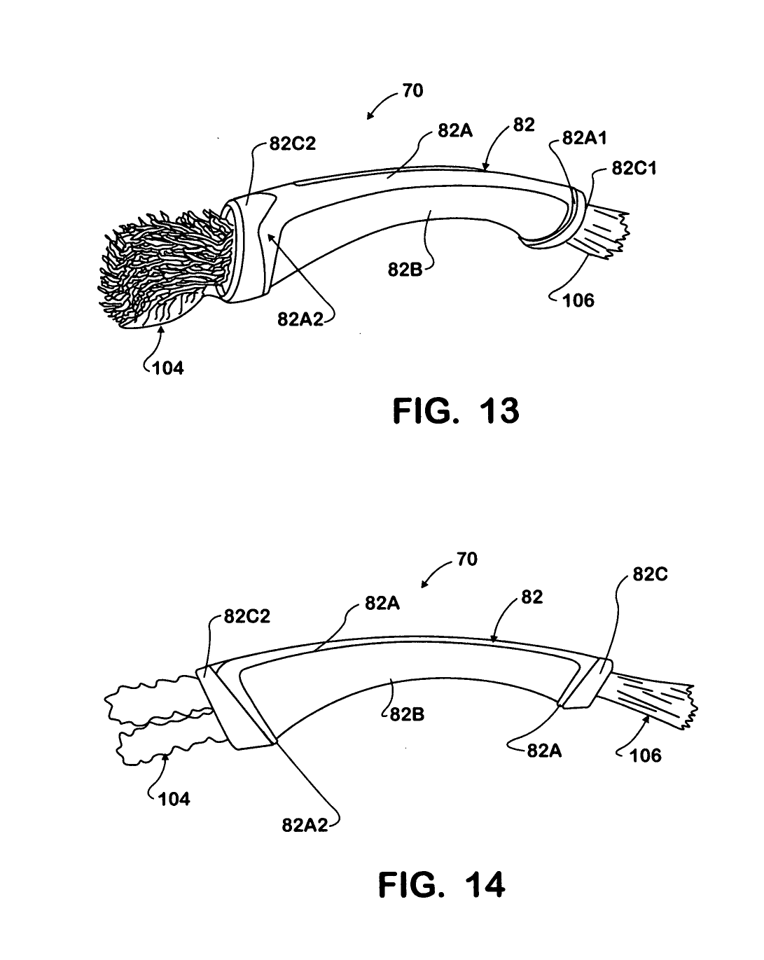

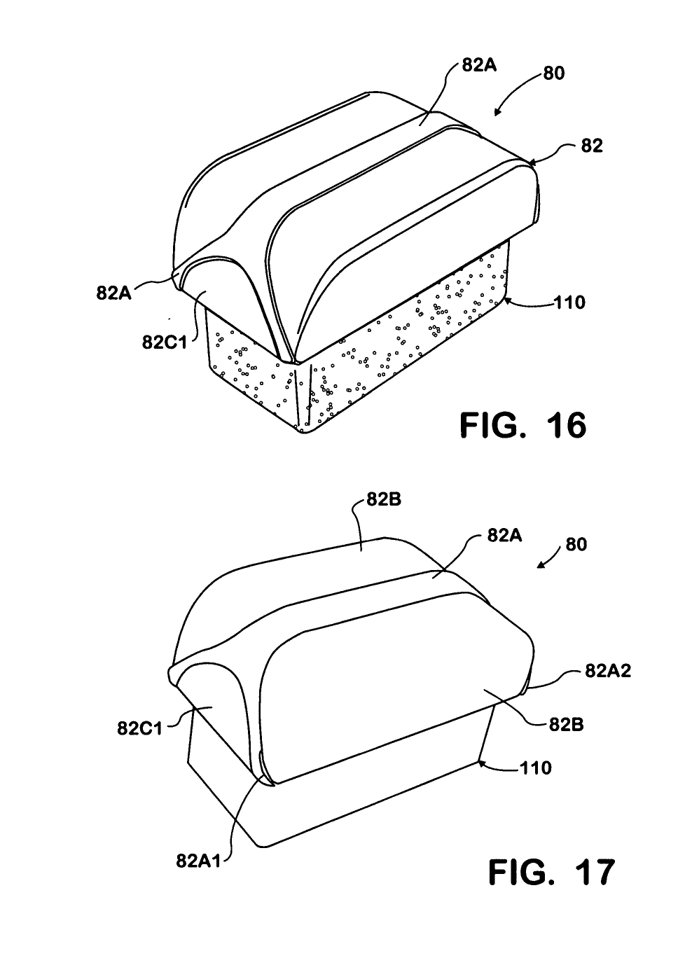

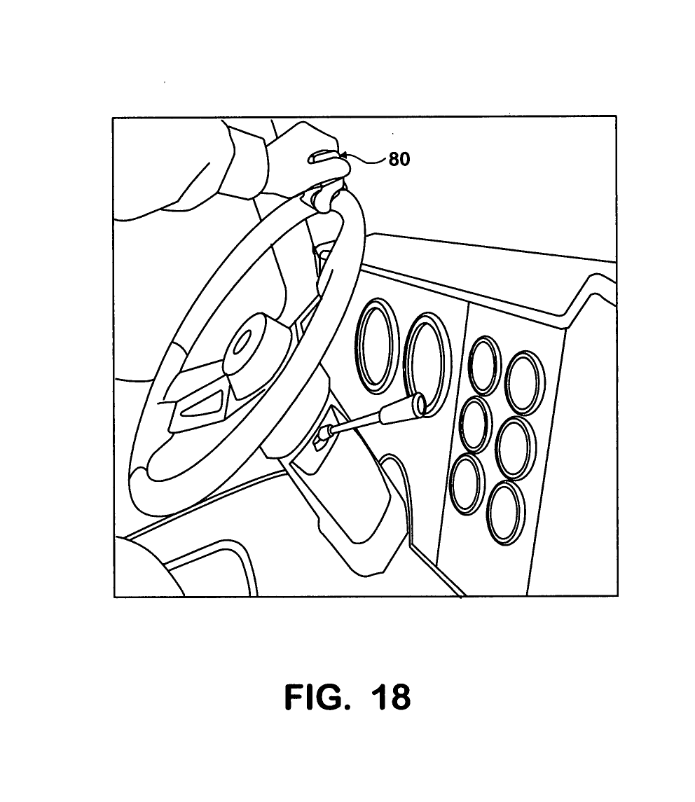

For illustrating principles of the invention, the drawings show the six tools just mentioned comprising, in order of the drawings, a duster 30 (FIGS. 1-3), a crevice tool 40 (FIGS. 4-6), a large brush 50 (FIGS. 7-9), a round brush 60 (FIGS. 10-12), a vent brush/fine dusting tool 70 (FIGS. 13-15), and a wiper tool 80 (FIGS. 16-18).

Each tool comprises a respective handle identified by the common numeral 82 because they share common inventive features although it is to be understood that their sizes and shapes are different. Each tool also comprises at least one cleaning element attached to the handle.

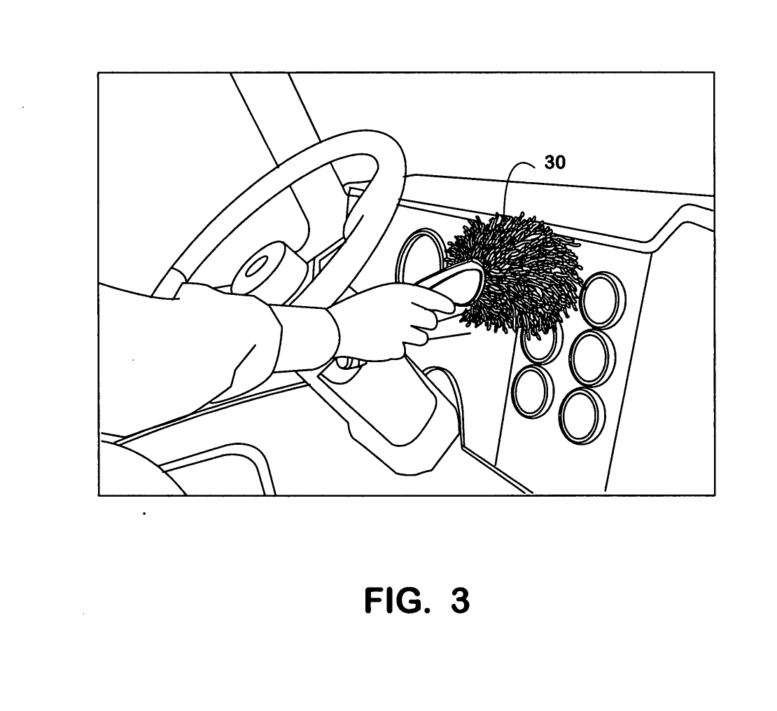

Duster 30 comprises a duster element 84 attached to one end of its handle 82. It has an overall length of about twelve inches. Duster 30 can be used to remove dust from most exposed harder surfaces throughout the interior of a truck or automobile, such as the instrument panel and dash. FIG. 3 illustrates duster 30 being used to dust the instrument panel and dash area of a truck. It can be seen that handle 82 has a size suitable for enabling duster 30 to be conveniently gripped.

Duster element 84 has a somewhat bulbous cylindrical shape that can be used to dust both open and somewhat confined spaces. It comprises multiple tightly woven soft yarn strands providing broad surface coverage and essentially scratch-free dusting of surfaces being dusted. These yarn strands are coated with a wax substance that builds a small static charge for attracting and trapping dust. Trapped dust is released from element 84 only when the user vigorously shakes the duster, and that of course would be done outside the truck.

Duster 30 has a six inch long handle and an overall length of twelve inches.

Crevice tool 40 comprises a larger blade 86 at one lengthwise end of its handle 82 and a smaller blade 88 at the opposite lengthwise end. This tool is used to remove dirt particles and dust from small crevices, both in hard surfaces such as those around rims of instrument panel gauges and those in soft surfaces such as seat seams. The tool is approximately eight inches in overall length. Each blade 86, 88 is made of the same synthetic material (santoprene) to have a similar overall shape. However, each solves a different cleaning problem.

Blade 86 allows the user to swipe along broad crevices and edges on the instrument panel in one smooth motion. Blade 88 allows for finer cleaning in tighter areas such as around knobs and gauges. Because of the properties of the blade material, dust and dirt particles actually stick to their surface until wiped clean. Handle 82 of this tool is noticeably thinner than those of the other long tools—it's somewhat pencil-shaped—because of the detail-oriented and precision nature of the task to be performed.

Each blade 86, 88 has a wedge-shape that is defined by a flat top surface 81, and convex sides 85 that meet at a bottom edge 87 curving upwardly away from handle 82 to a pointed tip 89 at an end of top surface 81 that is distal to the handle.

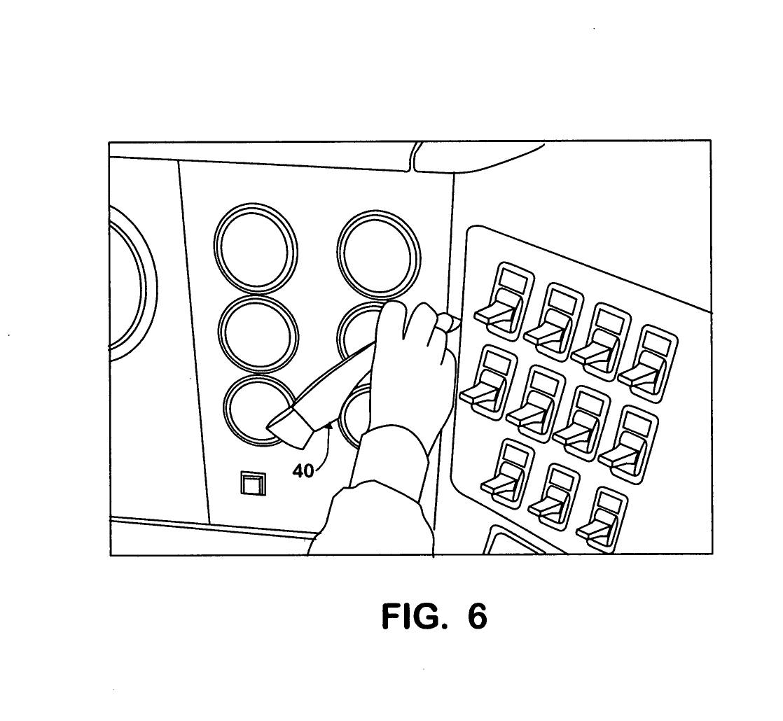

FIG. 6 illustrates the crevice tool in use with the small blade being worked around a groove in a cluster of instrument panel switches. It can be seen that handle 82 provides for the tool to held in the hand in a manner similar to how a writing instrument like a pencil would be held.

Crevice tool 40 has a seven inch long handle and an overall length of eight and one quarter inches.

Large brush 50 comprises a bristle holder 90 with bristles 92 on its bottom face that are generally downwardly pointing. As viewed in plan bristle holder 90 has a generally triangular-shape. Its top face is rounded and includes a short stem 99 to which one end of handle 82 is attached. Large brush 50 is used to scrub away mud and dirt from the floor of a truck or automobile.

Bristle holder 90 comprises a flexible element 94 that joins the proximal edge of a distal portion 96 of the holder and the distal edge of a proximal portion 98 of the holder so as to allow distal portion 96 to swing upwardly relative to proximal portion 98 as suggested by arrow 100.

The bristles are a combination of rubber bristles and strong nylon or polypropylene bristles, enabling the large brush both to scrub away dirt and to collect strands and hairs so that such pieces of debris are not kicked up into the air as might occur with other floor brushes.

Element 94 is essentially a resilient hinge that allows the distal end portion of the brush to maintain contact with the surface being swept as the user moves the handle back and forth while brushing. This feature allows the user to take a full stroke from front to back while maintaining substantial floor coverage as the orientation of the gripping hand changes during the sweep of a brush stroke.

The materials of the large brush are resistant to commonly used cleaning chemicals. The large brush can impart a quality shine to a surface being brushed when used with any number of cleaning agents. Because a cleaning task may require vigorous scrubbing, the large brush has a large palm-sized handle for comfort.

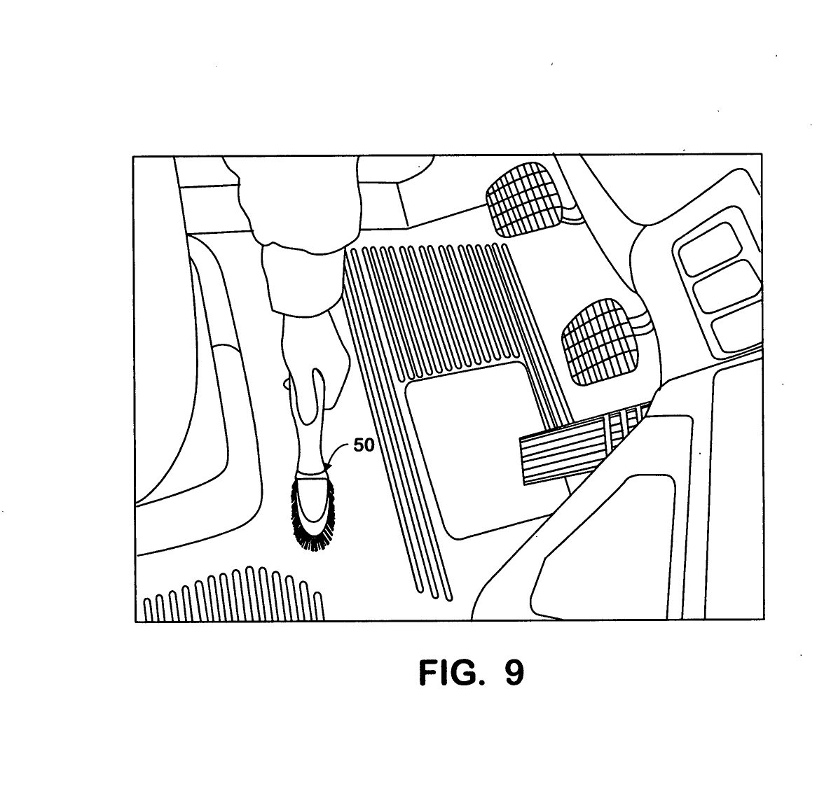

FIG. 9 shows large brush 50 being used to sweep the floor and mats. The strong synthetic bristles are capable of breaking up accumulated dirt on the floor and mats. The rubber bristles help to sweep dust, tiny dirt fragments, strands, and hairs. Large brush 50 has a six inch long handle and an overall length of twelve inches.

The cleaning element of round brush 60 is a generally round brush head 102, about two inches in size, for scrubbing and/or collecting dirt from hard-to-reach compartments, such as cup holders and other depressions in a center console or elsewhere. Brush head 102 contains nylon bristles in a center zone for lighter scrubbing that can break apart encrusted material by themselves or in conjunction with treatment of the affected area by an applied chemical, such as a chemical spray. These synthetic bristles are surrounded by outer bristles made of wax-coated yarn to collect remaining dust and dirt particles.

The materials used in this tool are chosen to resist common cleaning chemicals. Like the large brush, the round brush handle 82 is sized to provide a solid, comfortable, palm-sized grip for heavy scrubbing tasks. FIG. 12 shows the round brush being used to clean out compartments, such as cup holders and the like.

Round brush 60 has a six inch long handle and an overall length of eight inches.

The vent brush/fine dusting tool 70 comprises a vent cleaning brush 104 at one lengthwise end of its handle 82 and a fine dusting brush 106 at the opposite end. Vent cleaning brush 104 is used to remove dust from louvered vents or registers, such as air ventilation registers in the instrument panel. Fine dusting brush 106 is used to sweep away dust and fine dirt particles, such as may be left behind after use of the crevice tool. Tool 70 has a size similar to that of the crevice tool with the thinner handle allowing it to be used for finer tasks than those performed using the large brush and the round brush.

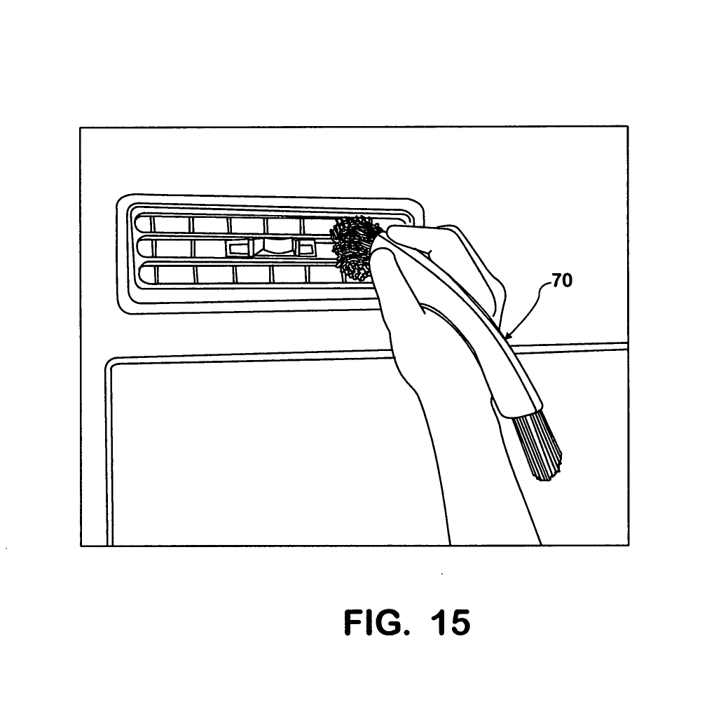

As best seen in FIG. 14, the vent cleaning brush 104 is bifurcated to allow a vent louver to fit between the bifurcations. Each bifurcation comprises yarn, cotton or acrylic, attached to a central wire by folding the wire in half, inserting yarn strands the halves of the wire, and then twisting the wire to lock the bristles in place. The stems of the wires are secured on the end of the handle in any suitably appropriate way. The thickness of each bifurcation can be made large enough not only to brush the opposite surfaces of the louver between them but also the confronting surfaces of immediately adjacent louvers.

The fine dusting brush 106 comprises a bundle of camel hairs to dust away fine particulates. The bundle is secured to the opposite end of the handle and secured in any suitable manner.

FIG. 15 shows brush 104 in use cleaning louvers of an air outlet register in the instrument panel.

The vent brush/fine dusting tool 70 has a six inch long handle and an overall length of nine inches.

Wiper tool 80 is used to wipe and/or polish surfaces, with or without accompanying use of chemicals. The wiper tool comprises a deformable foam sponge 110 and clips that are obstructed from view due to the viewing direction of the Figures. The clips function to clamp margins of a separate cleaning wipe or paper towel that is placed over the bottom face of the sponge and wrapped against opposite sides of the sponge, attaching to the clips on the undersides of the handle that is wider than the sponge. After a wipe or towel has been attached to the tool, the sponge allows the wipe or towel to conform to irregular surfaces being wiped or polished without the need to use significant pressure. Chemicals can also be applied to the wipe.

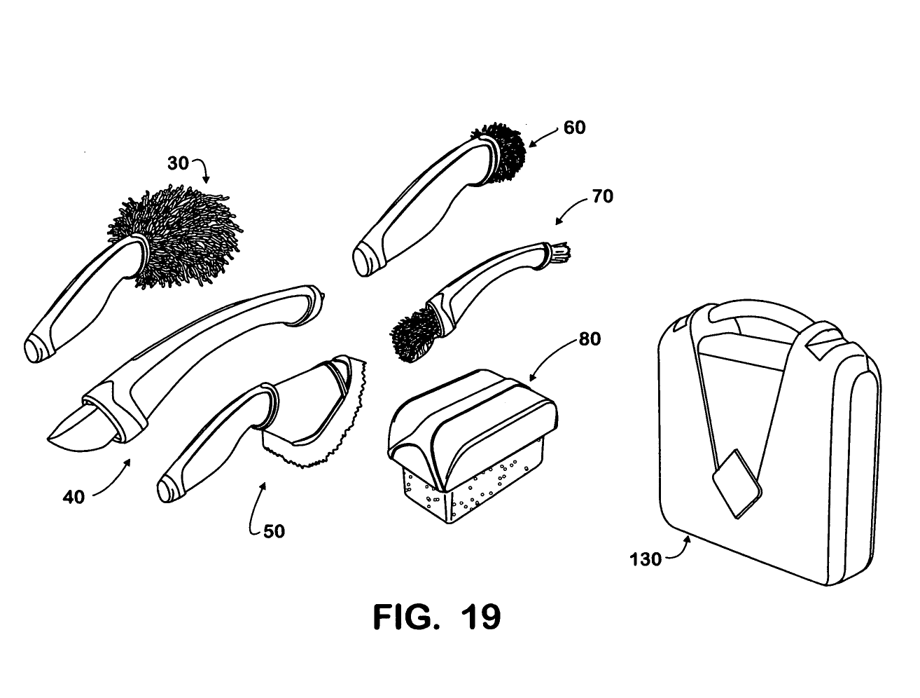

FIG. 18 shows tool 80 being used with a wipe or towel over the sponge. After use of any of the tools, they can be rinsed with water and/or or shaken to release the dust and dirt that has collected on them.

Wiper tool 80 has a length of four inches, an overall height of three inches, and an overall width of three inches.

The construction of the handles is an important aspect of the invention. Each handle comprises a main high-density polyethylene body 82A having recesses running lengthwise along opposite sides for a majority of the length of the main body. The recesses can merge at the underside of the handle or end short of each other along the underside. Main body 82A is therefore basically chemically inert and possesses dimensional stability suited for the intended use of the tools.

The side recesses in the main body are filled with a thermoplastic elastomer 82B, such as Santoprene®, to complete the gripping area of the handle. The thermoplastic elastomer possesses physical characteristics that provide comfortable, yet sure, gripping of the tools in both wet and dry environments. In conjunction with the upwardly convex and downwardly concave shapes of most of the handles, the thermoplastic elastomer sides that occupy a majority of the gripping area providing impart comfort and good ergonomic characteristics to those handles. If the side recesses merge at the underside, the main body is not exposed at the underside. If the side recesses stop short of each other at the underside, there is an intervening portion of the main body separating them and appearing as a band running lengthwise centrally along the underside.

The handles are completed by high-density polyethylene end caps 82C1, 82C2.

The thermoplastic elastomer of fillings 82B combines certain characteristics of rubber and plastic. It too is generally inert, durable, and light in weight. It possesses a certain softness to the grasp but without excessive deformation even when squeezed tightly. It also has noticeable surface friction that is beneficial in avoiding slippage of the hand when grasping the handle.

The handles are completed by high-density polyethylene end caps 82C1, 82C2. The appropriate cleaning element or elements is or are then attached to the completed handle.

A three-step injection molding process is employed to make the handles. First the main body 82A is fabricated by injection molding in a suitable mold. Then the main body is placed in another mold, and there the thermoplastic elastomer is injected into the side recesses in the main body to compete the gripping area of the handle. Then the partially completed handle is placed in a third mold where the end caps are molded onto the ends of the handle.

For the purpose of correlating the tools with the identity of a particular brand or type of vehicle, the handles have certain features. Those features include the colors that are used for the handle materials and the shapes of the end caps in relation to the shapes of the main body and the side fillings.

For example, end cap 82C has a triangular point pointing toward the user. The overmolded end caps are left short of the side recesses in main body 82 to allow a bands 82A1, 82A2 of main body material to be present between the end caps and the fillings 82B in the recesses.

Further identification is imparted to the handles by making the main body, the fillings, and the end caps each a distinctive color. For example the main body can be orange, the fillings black, and the end caps brushed chrome.

In the case of the large brush the rubber bristles around the perimeter are created concurrently with the injection of thermoplastic elastomer that forms fillings 82. The other bristles are inserted by a drill and fill CNC machine that locates and drills the holes after which a plunger taps the bristles into the holes.

In the case of the crevice tool, the blades 86, 88 are created concurrently with the injection of thermoplastic elastomer that forms fillings 82.

FIG. 19 shows the tools and their carrying case 130 which is also made by a three-step injection molding process. The first injection will be of the HDPE for the main body of the case. Then a second HDPE injection will create wood-like pieces for the handle and detail on the case. A third injection will add chrome details. The hardware for the case will be assembled last. The tray the holds the tools inside the case will be a separate injection mold of HDPE.

The case is hinged in two places, one exterior and one interior. The primary exterior hinge opens the overall case, exposing the tools and the handles. The secondary internal hinge allows the tools to lift up, exposing a storage area that can be used for wipes or other important tools. Two heavy-duty exterior clips firmly keep the case closed, but can easily open in one fluid motion when necessary.

While a presently preferred embodiment of the invention has been illustrated and described, it should be appreciated that principles of the invention apply to all embodiments falling within the scope of the invention that is defined as follows.

What is claimed is:

1. A cleaning tool comprising:
a cleaning element;
and a handle to which the cleaning element is attached, which is sized for single-handed grasping, and which comprises a main body of injection-molded plastic having a particular color and comprising recesses running lengthwise along opposite sides of the main body for a majority of the length of the main body, plastic of a different color that has been injection-molded onto opposite lengthwise ends of the main body, and thermoplastic elastomer that has been injection-molded to fill the side recesses of the main body.

2. A cleaning tool as set forth in claim 1 wherein the recesses stop short of opposite lengthwise ends of the main body and the thermoplastic elastomer that has been injection-molded to fill the side recesses is spaced from the plastic that has been injection-molded onto opposite lengthwise ends of the main body, so as to create the appearance of a band of the main body separating the thermoplastic elastomer that has been injection-molded to fill the side recesses from the plastic that has been injection-molded onto opposite lengthwise ends of the main body.

3. A cleaning tool as set forth in claim 2 wherein the thermoplastic elastomer that has been injection-molded to fill the side recesses of the main body has a color different from that of both the plastic of the main body and the plastic that has been injection-molded onto opposite lengthwise ends of the main body.

4. A cleaning tool as set forth in claim 3 wherein the thermoplastic elastomer that has been injection-molded to fill the side recesses of the main body presents greater surface friction to a person's hand grasping the handle than does the plastic of the main body and forms a greater portion of the area of the lengthwise surface of the handle than does the main body.

5. A cleaning tool as set forth in claim 4 wherein the handle has a curvature that is upwardly convex and downwardly concave when grasped by a person's hand for use.

6. A cleaning tool as set forth in claim 5 wherein the cleaning element comprises a brush.

7. A cleaning tool as set forth in claim 6 comprising an additional cleaning element, each cleaning element being attached to a respective lengthwise opposite end of the handle.

8. A cleaning tool as set forth in claim 7 wherein the additional cleaning element comprises a brush that is different from the other brush.

9. A cleaning tool as set forth in claim 5 wherein the cleaning element comprises a wedge-shaped blade that is disposed at one lengthwise end of the handle and that has a flat top and convex sides that meet at a bottom edge curving upwardly away from the handle to a pointed tip at an end of the flat top distal to the handle.

10. A cleaning tool as set forth in claim 9 further comprising an additional wedge-shaped blade that is disposed at the opposite lengthwise end of the handle, that has a flat top and convex sides that meet at a bottom edge curving upwardly away from the handle to a pointed tip at an end of the flat top distal to the handle, and that is smaller than the blade at the other end.

11. A cleaning tool as set forth in claim 4 wherein the cleaning element comprises a sponge disposed on a bottom surface of the handle.

12. A kit comprising:
a carrying case for a set of cleaning tools;
a set of cleaning tools for carrying in the case, where each tool comprises a respective handle to which a respective cleaning element is attached;
each handle being sized for single-handed grasping and comprising a main plastic body comprising recesses running lengthwise along opposite sides of the main body for a majority of the length of the main body, thermoplastic elastomer filling the side recesses of the main body, and plastic end caps disposed on the main body at lengthwise opposite ends of the main body beyond the thermoplastic elastomer in the side recesses.

13. A kit as set forth in claim 12 wherein color of the main body differs from the color of the thermoplastic elastomer filling the side recesses of the main body, and the color of the end caps differs from both the color of the main body and the color of the thermoplastic elastomer filling the side recesses of the main body.

14. A kit as set forth in claim 13 wherein the set of cleaning tools comprises at least one brush tool and at least one crevice tool.

15. A kit as set forth in claim 14 wherein one brush tool comprises a generally triangularly-shaped bristle holder comprising an element that allows a distal portion of the holder to swing upwardly relative to a proximal portion of the holder, and bristles on bottom faces of both distal and proximal portions of the holder.

16. A kit as set forth in claim 14 wherein one brush tool comprises different brushes at respective opposite lengthwise ends of the handle.

17. A kit as set forth in claim 14 wherein one crevice tool comprises a wedge-shaped blade that is disposed at one lengthwise end of the handle and that has a flat top and convex sides that meet at a bottom edge curving upwardly away from the handle to a pointed tip at an end of the flat top distal to the handle.

18. A kit as set forth in claim 18 wherein the one crevice tool further comprises an additional wedge-shaped blade that is disposed at the opposite lengthwise end of the handle, that has a flat top and convex sides that meet at a bottom edge curving upwardly away from the handle to a pointed tip at an end of the flat top distal to the handle, and that is smaller than the blade at the other end.

19. A kit as set forth in claim 14 including a further tool whose cleaning element comprises sponge disposed on a bottom surface of the handle.

20. A kit as set forth in claim 19 wherein the further tool has a mechanism for releasably holding a sheet of material in covering relation to a bottom surface of the sponge.
